(19) United States
(12) Patent Application Publication
(10) Pub. No.: US 2026/0099945 A1
(43) Pub. Date: Apr. 9, 2026

(54) INFORMATION PROCESSING APPARATUS, PROGRAM, AND INFORMATION PROCESSING METHOD

(71) Applicant: Sony Semiconductor Solutions Corporation, Kanagawa (JP)

(72) Inventor: Tsubasa KUROKAWA, Kanagawa (JP)

(73) Assignee: Sony Semiconductor Solutions Corporation, Kanagawa (JP)

(21) Appl. No.: 19/114,794

(22) PCT Filed: Sep. 29, 2023
(86) PCT No.: PCT/JP2023/035683

§ 371 Date: Mar. 25, 2025

(30) Foreign Application Priority Data
Oct. 19, 2022 (JP) 2022-167867

(51) Int. Cl. G06T 7/73; G06T 7/80; G06T 11/00; G06V 10/40

(52) U.S. Cl. CPC G06T 7/75; G06T 7/80; G06T 11/00; G06V 10/40; G06T 2207/10028

(57) ABSTRACT

An information processing apparatus includes, a matching circuit that receives a first image indicating a field of view in a prescribed space based on three-dimensional point cloud data that represents the prescribed space by a point cloud and a second image captured in the prescribed space, and matches the second image and the first image, and a position information providing circuit that generates second position information based on first position information about an origin of the field of view indicated by the first image matched with the second image and provides the second position information to update the three-dimensional point cloud data.

### TECHNICAL FIELD

The present disclosure relates to an information processing apparatus, a program, and an information processing method.

### BACKGROUND ART

Technology is known that generates three-dimensional point cloud data that represents the environment around a sensor such as a camera by three-dimensional points by using images of the surrounding environment captured with the sensor. For example, PTL 1 discloses a self-position estimator that generates three-dimensional point cloud data of the surrounding environment from images of the driving environment collected by a camera and estimates its own position on the basis of the three-dimensional point cloud data.

### CITATION LIST

### Patent Literature

PTL 1: JP 2022-026832A

### SUMMARY

### Technical Problems

When three-dimensional point cloud data that represents a prescribed space is generated on the basis of images of the prescribed space as described in the above technology, as the accuracy of the position information indicating the image-capturing position of each image increases, the accuracy of the three-dimensional point cloud data can be improved.

Therefore, the present disclosure proposes novel and improved technology that allows the accuracy of position information about a captured image of a prescribed space to be improved on the basis of a three-dimensional point cloud that represents the space.

### Solution to Problems

In order to solve the described problem, an information processing apparatus according to one aspect of the present disclosure includes a matching circuit that receives a first image indicating a field of view in a prescribed space based on three-dimensional point cloud data that represents the prescribed space by a point cloud and a second image captured in the prescribed space, and matches the second image and the first image, and a position information circuit that generates second position information based on first position information about an origin of the field of view indicated by the first image matched with the second image and provides the second position information to update the three-dimensional point cloud data.

Furthermore, according to the present disclosure, a readable storage device having computer readable instructions that when executed by circuitry cause the circuitry to match a second image captured in the prescribed space and a first image indicating a field of view in a prescribed space based on three-dimensional point cloud data that represents the prescribed space by a point cloud, and generate second position information based on first position information about an origin of the field of view indicated by the first image matched with the second image and provides the second position information to update the three-dimensional point cloud data.

Furthermore, according to the present disclosure, an information processing method executed by a computer is provided, and the method includes matching a second image captured in the prescribed space and a first image indicating a field of view in a prescribed space based on three-dimensional point cloud data that represents the prescribed space by a point cloud, and generating second position information based on first position information about an origin of the field of view indicated by the first image matched with the second image and providing the second position information to update the three-dimensional point cloud data.

### BRIEF DESCRIPTION OF DRAWINGS

FIG. 1 is a view for illustrating the outline of an information processing system according to an embodiment of the disclosure.

FIG. 2 is a block diagram for illustrating an exemplary functional configuration of an external device 10 according to the embodiment.

FIG. 3 is a block diagram for illustrating an exemplary functional configuration of an information processing apparatus 20 according to the embodiment.

FIG. 4 is a block diagram for illustrating an exemplary functional configuration of a position correction unit 30 according to the embodiment.

FIG. 5 illustrates position information extraction processing by an extraction unit 330.

FIG. 6 illustrates image generation processing by an image generation unit 350.

FIG. 7 illustrates matching processing by a matching unit 370.

FIG. 8 illustrates production of position information for correction by a position information providing unit 390.

FIG. 9 is a diagram for illustrating an exemplary functional configuration of a point cloud processing unit 40 according to the embodiment.

FIG. 10 illustrates generation of new point cloud data by a three-dimensional point cloud generation unit 410.

FIG. 11 illustrates updating of three-dimensional point cloud data by an integration unit 430.

FIG. 12 is a flowchart for illustrating an example of the operation of the information processing system according to the embodiment.

FIG. 13 is a block diagram for illustrating an exemplary functional configuration of an external device 11 according to a first modification.

FIG. 14 is a block diagram for illustrating an exemplary functional configuration of a position correction unit 31 according to the first modification.

FIG. 15 illustrates image generation processing by an image generation unit 351.

FIG. 16 is a flowchart for illustrating an example of the operation of the information processing system according to the first modification.

FIG. 17 is a block diagram for illustrating an exemplary functional configuration of an external device 12 according to a second modification.

FIG. 18 is a block diagram for illustrating an exemplary functional configuration of a position correction unit 33 according to a third modification.

FIG. 19 illustrates image processing by a matching unit 373.

FIG. 20 is a flowchart for illustrating an example of the operation of an information processing system according to the third modification.

FIG. 21 is a view for illustrating a system configuration of an information processing system according to a modification of the embodiment.

FIG. 22 is a view for illustrating a system configuration of an information processing system according to another modification of the embodiment.

FIG. 23 is a block diagram of an exemplary hardware configuration 90.

### DESCRIPTION OF EMBODIMENTS

Preferred embodiments of the present disclosure will be described in detail in conjunction with the accompanying drawings. Note that elements having substantially the same functional configurations are designated by the same reference characters in the description and drawings, and their descriptions will not be repeated.

In the description and drawings, a plurality of elements having substantially the same functional configurations may be distinguished by affixing different numbers or alphabets after the same reference characters. However, when there is no particular need to distinguish the plurality of elements having substantially the same functional configurations, these elements are designated only by the same reference characters.

Note that the description will be given in the following order.
1. Outline
2. Exemplary Configuration
2-1. Device
2-2. Information Processing Apparatus
3. Operation Example
4. Modifications
4-1. First Modification
4-2. Second Modification
4-3. Third Modification
4-4. Modification of System Configuration
5. Hardware Configuration
6. Conclusion

### 1. OUTLINE

The present disclosure relates to an information processing system that corrects position information obtained as an image-capturing position of images of a prescribed space and generates three-dimensional point cloud data that represents the prescribed space by a point cloud on the basis of the images and the corrected position information. More specifically, the present disclosure relates to an information processing system based on SfM (Structure from Motion) technology that allows images of a prescribed space captured from multiple viewpoints to be obtained using a camera or any other sensor and a three-dimensional point cloud of the prescribed space to be generated from the multiple images. Hereinafter, as a preferred application of the present disclosure, an example of how to generate and update three-dimensional point cloud data that represents a construction site by a point cloud using a group of images obtained by capturing the construction site from multiple viewpoints will be described. The generated three-dimensional point cloud data may be used for example for managing construction progress. The construction site is an example of the prescribed space.

### (Outline of Problems)

As described above, SfM has been known as a technique that uses a group of images of an object taken multiple times from multiple viewpoints (multiple different positions or angles) and restores the positions where the images have been taken and the three-dimensional structure of the image-captured object (target space). As a general approach according to SfM, feature points common among the entire group of images are first identified from the captured images. Furthermore, by mapping the identified feature points among the images from different viewpoints, the three-dimensional structure of the image-captured object can be restored. Each of the images may be a moving image or a still image.

When measuring the shape of an object (target space), the shape measurement system can be improved by acquiring images from viewpoints as different as possible and taking corresponding points among the images. In this case, when the images to be used have more effective pixels, more detailed analysis can be carried out.

In the correspondence between the acquired images from the different viewpoints, the initial values of the position and posture of the camera used to capture the images must be given correctly to some extent. If the camera has a positioning function, the position information obtained by the camera can be used as an initial values. In order to generate more accurate three-dimensional point cloud data, it is desirable to acquire more accurate position information about the image-capturing positions where the images have been captured.

As an example of application of the above technique, three-dimensional point cloud data about topographic features may be generated using a group of overhead images taken by a drone. For example, if a group of overhead images can be acquired on a daily basis and three-dimensional point cloud data can be generated from the group of overhead images, topographic information can be acquired on a daily basis. Such topographic information can be used for progress management at buildings or construction sites where the topography changes daily and over time.

Here, a positioning method using GNSS (Global Navigation Satellite System) is generally used as the positioning function of a drone. For example, among positioning methods using GNSS satellites, in a stand-alone positioning method that uses a single GPS (Global Positioning System) receiver to receive signals from a GPS satellite for positioning, the error of the positioning accuracy is known to be about 10 m to 15 m. In the DGPS (Differential GPS) method, which uses signals from GPS satellites plus correction information, the error of the positioning accuracy is known to be about 1 m or less.

In order to obtain position information with an accuracy with an error of a few centimeters (hereinafter, cm-class), for example, with an error of 1 cm to 10 cm, using a general-purpose GPS receiver, a dedicated antenna module is required. Known examples of antenna modules include RTK (Real-Time Kinematic) modules that acquire correction information from a unique reference station on the ground. In this case, a dedicated custom product may be required instead of a general-purpose drone, which has the disadvantage of increasing the price cost of the drone as compared to a general-purpose product. Other than drones, images and position information may be acquired using a camera and a GPS receiver provided by a vehicle traveling on the ground, but since the antenna module as described above must be connected to a camera or control module, it is difficult to mount the module on a vehicle which is not intended to be connected to any external device.

In addition, when a drone is used to capture images of a target space, anti-aircraft signs must be set up and takeoff and landing sites must be secured in advance as preparation, and cleanup is required afterwards. As the area to be covered expands, more time and effort is required to set up anti-aircraft signs. Especially at construction or building sites, there may be time constraints for preparation and cleanup so as not to interfere with daytime construction works. In addition, when a drone is used, compliance with laws and regulations may be required, such as flight restrictions in densely populated areas such as urban areas, and the need to obtain a flight permit. Therefore, it is not easy to acquire overhead images by a drone in daily cycles, for example, at a construction site or a building site.

Furthermore, it is difficult to generate three-dimensional point cloud data on vertical surfaces such as walls on the ground or cliffs only from overhead images acquired by a drone.

In the information processing system according to one embodiment of the present disclosure, cameras commonly used at a construction site, such as cameras mounted on construction equipment or surveillance cameras, are used to acquire images of the construction site. In addition, the position information obtained from the positioning function of each camera is corrected to a more accurate position information on the server side. In addition, the three-dimensional point cloud data generated using the group of images after position information correction is used to enable the three-dimensional point cloud data to be updated in prescribed cycles.

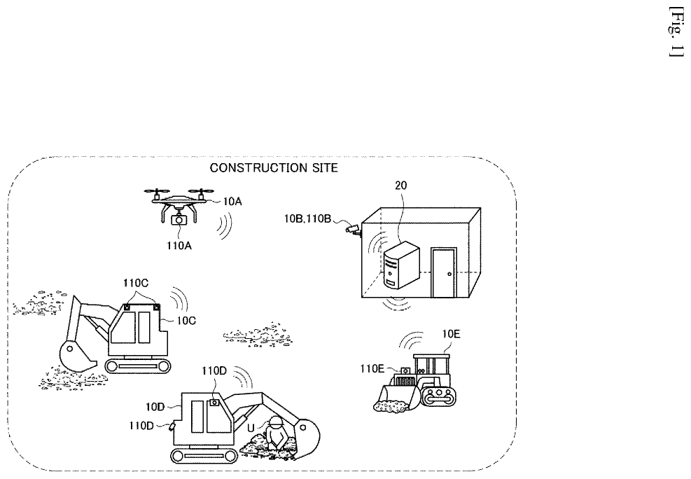

FIG. 1 is a view for illustrating the outline of the information processing system according to the embodiment of the disclosure. As shown in FIG. 1, the information processing system includes an external device 10 and an information processing apparatus 20. As also shown in FIG. 1, the information processing system includes a plurality of external devices 10, i.e., external devices 10A to external devices 10E.

### (External Device 10)

The external devices 10 are various devices that are each provided with a camera 110 and capable of capturing images of a prescribed space. The external devices 10 capture images of a construction site in multiple different positions or directions.

The external device 10 has the function of calculating its own position information using GNSS. The external device 10 provides the calculated position information to each image taken by the camera 110 as an image-shooting position.

The external device 10 may include a storage device capable of temporarily storing the captured images of the construction site. The external device 10 transmits a group of images of the construction site stored in the storage device to the information processing apparatus 20. The information processing apparatus 20 generates and updates three-dimensional point cloud data representing the construction site as a point cloud on the basis of the image group received from the external device 10.

The external device 10 may include any of various devices if the external device 10 has at least a camera for capturing images of the surrounding environment and a communication function for transmitting the images to the information processing apparatus 20. For example, the external device 10 may be an unmanned mobile unit that moves under autonomous control or by remote control. The unmanned mobile unit may be a drone that flies under autonomous control or an unmanned aerial vehicle (UAV) that flies under remote control by an administrator. In the example shown in FIG. 1, the external device 10A is a drone that acquires overhead images of a construction site from the sky.

The external device 10 may also be any of various types of work machinery such as a construction machine generally used at a construction site. In the example shown in FIG. 1, the external device 10B is a surveillance camera installed at a construction site. The external devices 10C to 10E are working machines such as cranes or bulldozers used at the construction site. Construction machines are generally equipped with cameras that capture images of the surroundings of the construction machines in order to check the safety of the surroundings during operation. In this case, cameras 110C to 110E can be realized by the cameras.

In this way, the information processing system according to the embodiment acquires a group of images of a construction site by utilizing for example the cameras of construction machines and surveillance cameras generally used at construction sites. This reduces the time and effort required for advance preparation or cleanup afterwards to capture images of the construction site. Therefore, the initial cost of applying the information processing system can be reduced because the cost of introducing new equipment for capturing a group of images can be reduced. It is also easier to acquire images of the construction site at a desired frequency, for example, daily or semi-daily.

In addition, by utilizing the cameras in various image-capturing positions, such as cameras mounted on construction machines or surveillance cameras, images of the construction site from multiple viewpoints can be acquired. This allows a point cloud to have a higher density in three-dimensional point cloud data generated on the basis of such images. Therefore, the accuracy of the three-dimensional point cloud data can be improved.

### (Information Processing Apparatus 20)

The information processing apparatus 20 has the function of generating and updating three-dimensional point cloud data representing a prescribed space as a point cloud on the basis of a group of images received from the external device 10. In the example shown in FIG. 1, the information processing apparatus 20 generates and updates three-dimensional point cloud data representing a construction site as an example of a prescribed space.

The information processing apparatus 20 holds, in advance, three-dimensional point cloud data representing the construction site as a point cloud. In the three-dimensional point cloud data, the coordinates of the position of each point in the three-dimensional space are generated with an accuracy that has a small error (for example an error of a few centimeters or less) from the actual position in the prescribed space. For the sake of description, the three-dimensional point cloud data held in advance by the information processing apparatus 20 will be hereinafter referred to as high-accuracy three-dimensional point cloud.

The information processing apparatus 20 receives a group of images of a construction site from the external device 10. The information processing apparatus 20 has the function of correcting the position information provided to each image in the received group of images on the basis of the above-described high-accuracy three-dimensional point cloud data.

More specifically, the information processing apparatus 20 performs the following processing. First, the information processing apparatus 20 generates a two-dimensional image that shows a field of view that originates from the position indicated by the position information provided to each image in a three-dimensional space of high-accuracy three-dimensional point cloud data. Furthermore, the information processing apparatus 20 matches the image of the construction site received from the external device 10 with the generated two-dimensional image. The information processing apparatus 20 corrects the position information by updating the position information about each image received from the external device 10 on the basis of the position information (coordinates in the three-dimensional space) of the origin of the two-dimensional image matched with the image.

This allows the position information provided to each image by the external device 10 to be updated with more accurate information even when the positioning accuracy of the position information is coarse (for example when the error range is in the order of meters, and position information with an accuracy of a few centimeter-class is not available).

In particular, when the external device 10 is realized by a construction machine or a surveillance camera at a construction site, the position accuracy by the external device 10 may be coarse. Even in such a case, the information processing apparatus 20 can update the image-capturing position of each image acquired by the external device 10 with a higher accuracy by correcting the position information in the above described manner.

In addition, the information processing apparatus 20 generates new three-dimensional point cloud data representing the construction site as a point cloud on the basis of the group of images of the construction site after positional information correction. Hereinafter, the three-dimensional point cloud data will be referred to as the new point cloud data.

The information processing apparatus 20 uses the generated new point cloud data to update the previously held high-accuracy three-dimensional point cloud. This allows the information processing apparatus 20 to update the three-dimensional point cloud representing the construction site in response to changes in the topography at the construction site.

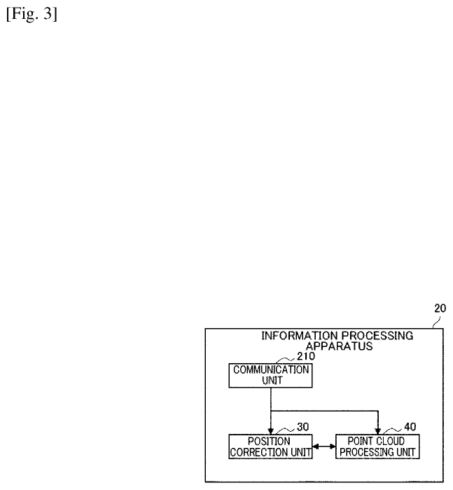

The overview of the information processing system according to the embodiment of the present disclosure has been described with reference to FIG. 1. Next, with reference to FIG. 3, an exemplary functional configuration of the external device 10 according to the embodiment will be described.

### 2. EXEMPLARY FUNCTIONAL CONFIGURATION

### <2-1. External Device 10>

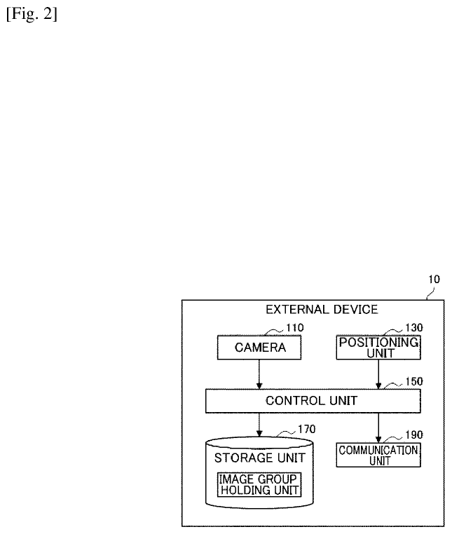

FIG. 2 is a block diagram for illustrating an exemplary functional configuration of the external device 10 according to the embodiment. As shown in FIG. 2, the external device 10 has a camera 110, a positioning unit 130, a control unit 150, a storage unit 170, and a communication unit 190. As used herein, “unit” refers to circuitry that may be configured via the execution of computer readable instructions, and the circuitry may include one or more local processors (e.g., CPU's), and/or one or more remote processors, such as a cloud computing resource, or any combination thereof.

### (Camera 110)

The camera 110 has the function of capturing images of a construction site. The camera 110 may be an RGB camera capable of acquiring images including color information.

The camera 110 may also be realized by a monocular camera or by a multi-lens camera such as a stereo camera. When the camera 110 is a stereo camera, the external device 10 may transmit only images from one of the left and right cameras or from both to the information processing apparatus 20.

### (Positioning Unit 130)

The positioning unit 130 has the function of calculating the absolute or relative position of the external device 10. For example, the positioning unit 130 may detect the current position in response to a signal acquired from an external source. Specifically, GNSS may be used, for example, to detect the current position of the external device 10 by receiving radio waves from a satellite. In addition to GNSS, Wi-Fi (Registered trademark), Bluetooth (Registered trademark), transmission and reception with cell phones, PHS, or smartphones or short-range communication may be used to detect the position.

### (Control Unit 150)

The control unit 150 has the function of controlling the overall operation of the external device 10. For example, the control unit 150 controls the communication unit 190 to transmit images captured by the camera 110 to the information processing apparatus 20.

The timing at which the control unit 150 causes the communication unit 190 to transmit the images to the information processing apparatus 20 can be set as appropriate according to the update frequency of the high-accuracy three-dimensional point cloud held by the information processing apparatus 20. For example, when the three-dimensional point cloud is used for daily construction progress management, the control unit 150 may cause the communication unit 190 to transmit the images to the information processing apparatus 20 at a prescribed time each day. Alternatively, the control unit 150 may cause the communication unit 190 to transmit the images to the information processing apparatus 20 upon receiving a request for transmission of the images from the information processing apparatus 20.

The control unit 150 may add position information indicating the image image-capturing location to each image acquired by the camera 110 using position information about the external device 10 calculated by the positioning unit 130. The position information may include information about the image-capturing direction of each image. For example, the external device 10 may include an azimuth sensor, which is not illustrated in FIG. 2, and information about the direction acquired by the azimuth sensor may be used as the image-capturing direction. Alternatively, if the external device 10 is installed in a fixed manner at the construction site, information about the image-capturing direction of the external device 10 may be held in the storage unit 170.

The control unit 150 causes each image provided with position information to be transmitted from the communication unit 190 to the information processing apparatus 20.

### (Storage Unit 170)

The storage unit 170 is a storage device capable of storing programs and data for operating the control unit 150. The storage unit 170 can also temporarily store various kinds of data required in the course of the operation of the control unit 150. For example, the storage device may be a nonvolatile storage device.

The storage unit 170 also functions as an image group holding unit that holds images acquired by the camera 110 according to the control of the control unit 150.

### (Communication Unit 190)

The communication unit 190 has the function of communicating with other devices according to the control of control unit 150. For example, the communication unit 190 transmits, according to the control of the control unit 150, a group of images held in the image group holding unit of the storage unit 170 to the information processing apparatus 20.

The exemplary functional configuration of the external device 10 has been described with reference to FIG. 2. Now, with reference to FIGS. 3, 4, and 9, an exemplary functional configuration of the information processing apparatus 20 according to the embodiment will be described.

### <2-2. Information Processing Apparatus 20>

FIG. 3 is a block diagram for illustrating an exemplary functional configuration of the information processing apparatus 20 according to the embodiment. As shown in FIG. 3, the information processing apparatus 20 has a communication unit 210, a position correction unit 30, and a point cloud processing unit 40.

The position correction unit 30 and the point cloud processing unit 40 each include an arithmetic operation unit such as a CPU (Central Processing Unit) and a GPU (Graphics Processing Unit), and the functions can be realized as the program stored in the ROM (Read Only Memory) is deployed in a RAM (Random Access Memory) and executed. At the time, a non-transitory computer-readable recording medium having the program recorded therein can also be provided. Alternatively, these blocks may be configured by dedicated hardware or realized by a combination of multiple pieces of hardware.

The data necessary for calculation by the arithmetic operation unit is stored as appropriate by each of a storage unit 310 and a storage unit 450 which will be described. The storage unit 310 and the storage unit 450 may include a memory such as a RAM, a hard disk drive or a flash memory.

### (Communication Unit 210)

The communication unit 210 has the function of communicating with other devices according to the control of the position correction unit 30. For example, the communication unit 210 acquires a group of images of a construction site from an external device 10. Hereinafter, an image and a group of images taken at a construction site that the communication unit 210 receives from the external device 10 are also referred to as the image A and the group of images A, respectively. The image A is an example of a second image.

### (Position Correction Unit 30)

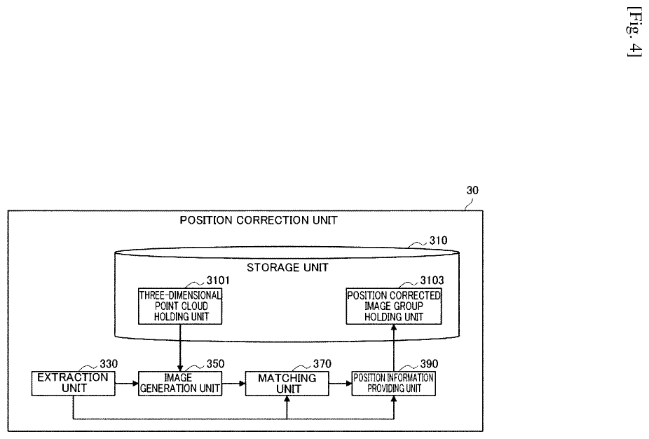

The position correction unit 30 has the function of performing a series of processing steps to add position information to each image included in the image group received from the external device 10. Referring now to FIG. 4, the function of the position correction unit 30 will be described in more detail.

FIG. 4 is a block diagram for illustrating an exemplary functional configuration of the position correction unit 30 according to the embodiment. As shown in FIG. 4, the position correction unit 30 has a storage unit 310, an extraction unit 330, an image generation unit 350, a matching unit 370, and a position information providing unit 390.

The storage unit 310 is a device for storing various types of data. The storage unit 310 functions as a three-dimensional point cloud holding unit 3101 and a position-corrected image group holding unit 3103.

The three-dimensional point cloud holding unit 3101 holds three-dimensional point cloud data (high-accuracy three-dimensional point cloud data) that represents a prescribed space. The three-dimensional point cloud data may be stored in the storage unit 310 in advance. Alternatively, the three-dimensional point cloud data may be generated by the information processing apparatus 20 in advance. Alternatively, the information processing apparatus 20 may acquire three-dimensional point cloud data generated by an external device and store the three-dimensional point cloud data in the three-dimensional point cloud holding unit 3101. Each piece of three-dimensional point data included in the three-dimensional point cloud data may also include color information.

The high-accuracy three-dimensional point cloud data held in the three-dimensional point cloud holding unit 3101 is three-dimensional point cloud data with a smaller position error about each point and a higher density than three-dimensional point cloud data that can be generated from a group of images acquired by the external device 10 using SfM.

For example, the high-accuracy three-dimensional point cloud data held in the three-dimensional point cloud holding unit 3101 may be generated on the basis of a group of images of a construction site taken for example by a drone including an antenna module capable of positioning with an error range in the order of centimeters.

The position-corrected image group holding unit 3103 holds the group of images A provided with position information for correction by the position information providing unit 390 which will be described.

The extraction unit 330 has the function of extracting the position information provided to each image included in the image group received from the external device 10. The position information provided to each image received from the external device 10 is an example of third position information. The extraction unit 330 outputs the extracted position information to the image generation unit 350.

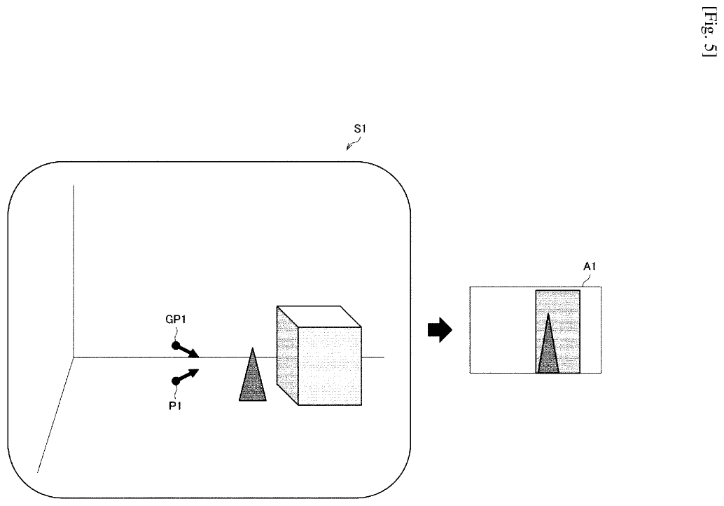

FIG. 5 is a diagram for illustrating position information extraction by the extraction unit 330. The space S1 represents the actual space of the construction site that is taken by the external device 10. The image A1 shows an example of an image taken by the external device 10 in the space S1 at the location and direction indicated by the position P1. The position GP1 indicates the position in the position information provided by the external device 10 to the image data of the image A1 as the image-capturing position.

The accuracy of the position GP1 provided to the image A1 by the external device 10 depends on the positioning accuracy of the positioning unit 130 of the external device 10. In the example shown in FIG. 5, it is understood that the position GP1 deviates from the position P1, which is the actual image-capturing position, and that an error has occurred.

The extraction unit 330 extracts the position information about the position GP1 provided to the image A1 from the data of the image A1. Further, the extraction unit 330 may convert the extracted position information about the position GP1 into three-dimensional rectangular coordinates in the three-dimensional space of the high-accuracy three-dimensional point cloud data.

The extraction unit 330 outputs the extracted position information to the image generation unit 350.

The extraction unit 330 also outputs the image data on each image included in the image group acquired from the external device 10 to the matching unit 370 and the position information providing unit 390.

The image generation unit 350 has the function of generating an image showing one field of view at the construction site on the basis of the high-accuracy three-dimensional point cloud data held in the three-dimensional point cloud holding unit 3101.

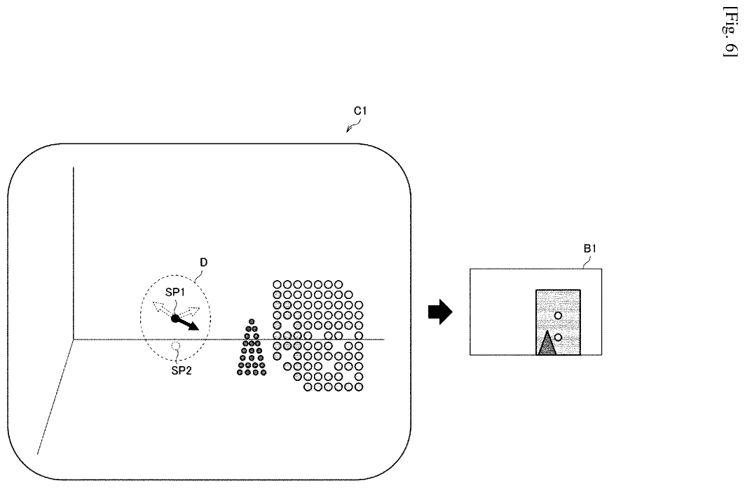

FIG. 6 illustrates image generation processing by the image generation unit 350. The point cloud C1 shown in FIG. 6 represents an example of a high-accuracy three-dimensional point cloud held in the three-dimensional point cloud holding unit 3101. The point cloud C1 is assumed to be high-accuracy three-dimensional point cloud data that represents the space S1 shown in FIG. 5 with three-dimensional points. The position SP1 indicates the position corresponding to the position GP1 on the high-accuracy three-dimensional point cloud data output from the extraction unit 330.

On the basis of the position information about the position SP1 output from the extraction unit 330, the image generation unit 350 generates a two-dimensional image showing one field of view having the position SP1 as the origin in the point cloud C1. The image B1 is an exemplary image of one field of view generated by the image generation unit 350 having the position SP1 as the origin.

At the time, the image generation unit 350 may select, as multiple origins, positions within a prescribed range from the position SP1 and generate multiple images showing the field of views from the origins. In the example shown in FIG. 6, the image generation unit 350 selects, as the origins, positions within the range D from the position SP1. For example, the image generation unit 350 may generate an image showing the field of view having the position SP2 the origin in addition to the position SP1.

The image generation unit 350 may also generate a plurality of images showing fields of view in a plurality of directions starting from the position SP1 as the origin. In the example shown in FIG. 6, the image generation unit 350 generates a plurality of images showing the fields of view when facing a plurality of different directions starting from the position SP1.

Herein, each of the images and image groups indicating the field of view having the position GP1 as the origin and generated by the image generation unit 350 on the basis of the high-accuracy three-dimensional point cloud data will also be referred to as the image B and the group of images B. The image B is an example of a first image.

The matching unit 370 has the function of matching the image A received from the external device 10 with the image B generated by the image generation unit 350 starting from the position indicated by the position information about the image A as the origin. When there are multiple images B generated from the position information provided to the single image A, the matching unit 370 performs matching between the image A and the generated multiple images B.

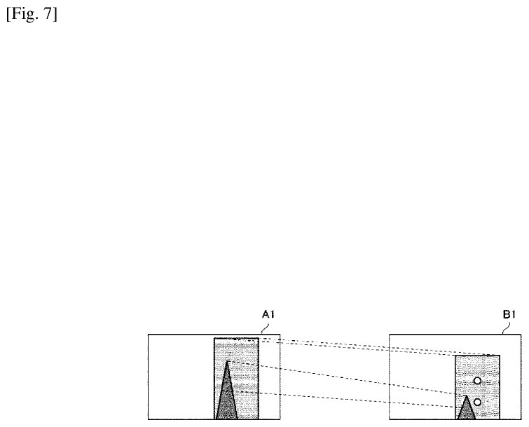

FIG. 7 illustrates the matching processing by the matching unit 370. The image A1 shown in FIG. 7 is an example of the image A. The image B1 is an example of the image B. The matching unit 370 may perform matching between the images A and B by extracting features from each of the images A and B and comparing the extracted features.

The matching unit 370 may also be configured by a trained neural network, and in this case, the feature quantities may be output from the trained neural network.

For example, the matching unit 370 may extract, from the images A and B, two-dimensional feature quantities, such as SIFT (Scale-Invariant Feature Transform) feature quantities or SURF (Speeded-Up Robust Features) feature quantities. The matching unit 370 may also perform matching between the images A and B by comparing the extracted features.

The matching unit 370 may also use other two-dimensional feature quantities as the feature quantities extracted from the images A and B. For example, the matching unit 370 may use RIFE (Rotation Invariant Feature Transform) feature quantities.

Alternatively, BRIEF (Binary Robust Independent Elementary Features) feature quantities, BRISK (Binary Robust Invariant Scalable Keypoints) feature quantities and CARD (Compact And Real-time Descriptors) feature quantities may be used as feature quantities to be extracted from the images A and B. For BRIEF, BRISK, and CARD feature quantities, a method for converting vector data into binary data is used as a feature quantity description method. Therefore, it is expected that memory consumption during the matching processing may be reduced and the calculation processing may be carried out at higher speed than the case in which feature quantities are described using higher-dimensional vector feature quantities.

The matching method for the images A and B by the matching unit 370 is not limited to the above, and other matching methods may be used. For example, the matching unit 370 may search for corresponding points in the images A and B and perform matching between the images A and B by Area-Based Matching. In this case, the matching unit 370 may use information on the internal parameters of the camera 110 that captured image A (such as the camera model, focal length during image capture, and image sensor size).

More specifically, for example, the matching unit 370 may calculate the degree of difference between the images A and B by calculating the sum of the absolute values of the differences in the luminance values of the pixels in the images A and B. In this case, the matching unit 370 may determine that the images A and B are more similar as the calculated sum is closer to zero. Such a method is referred to as SAD (Sum of Absolute Differences).

Alternatively, the matching unit 370 may calculate the degree of difference between the images A and B by calculating the sum of the squares of the luminance values of the pixels in the images A and B. Such a method is referred to as SSD (Sum of Squared Differences).

Alternatively, the matching unit 370 may determine the degree of similarity between the images A and B on the basis of the luminance values of the pixels in the images A and B, using the NCC (Normalized Cross Correlation) calculation method.

Alternatively, the matching unit 370 may perform matching using POC (Phase-Only Correlation), which matches the images A and B using phase information among kinds of information obtained by Fourier transforming the images A and B.

Alternatively, the matching unit 370 may perform matching between the images A and B by extracting contour information (edge information) from the images A and B and searching for the image B that has contour information similar to the extracted contour information about the image A.

If the matching unit 370 fails to match the images A and B, the image A may be discarded. The matching unit 370 outputs the matching result to the position information providing unit 390.

The position information providing unit 390 has the function of generating position information for correction on the basis of the position information about the origin of the field of view indicated by the image B matched with the image A. The position information about the origin of the field of view indicated by the image B matched with the image A is an example of first position information.

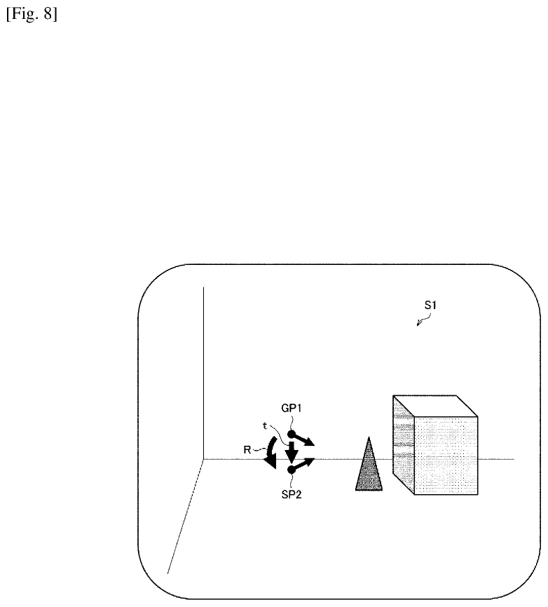

FIG. 8 illustrates calculation of the position information for correction by the position information providing unit 390. The space S1 shown in FIG. 8 represents the space of the construction site as described with reference to FIG. 5. In the description of the example shown in FIG. 8, the origin of the field of view shown by the image B matched with the image A is at the position SP2. The translation vector t shown in FIG. 8 represents a translation vector from the position GP1 to the position SP2. The rotation matrix R represents a rotation matrix that rotates the position GP1 around the origin in the three-dimensional space of the high-accuracy three-dimensional point cloud data so that the position moves to the position SP2. In FIG. 8, the position GP1 and the position SP2 are represented by coordinate values (x, y, z) in the three-dimensional rectangular coordinate system.

The position information providing unit 390 calculates the rotation matrix R and the translation vector t from the image A to the image B on the basis of the matching result by the matching unit 370. For example, the position information providing unit 390 may calculate the rotation matrix R and the translation vector t on the basis of corresponding points between the images A and B searched for in the matching processing by the matching unit 370.

When expressing the image-capturing direction of the image A using a three-dimensional vector in high-accuracy three-dimensional point cloud data in the rectangular coordinate system, the position information providing unit 390 may calculate the actual image-capturing direction (a, b, c) of the image A using the following expression.

$$( a , b , c ) = R \times {( Ga , Gb , Gc )}^{T} \qquad Expression 1$$

where (Ga, Gb, Gc) is the image-capturing direction of the image A, and (Ga, Gb, Gc)^{T} is the transposition matrix of (Ga, Gb, Gc).

Furthermore, the position information providing unit 390 may calculate the actual image-capturing position (X, Y, Z) of the image A using the following expression.

$$( X , Y , Z ) = t + ( GX , GY , GZ ) \qquad Expression 2$$

where (GX, GY, GZ) is image-capturing position provided to the image A by the external device 10.

The position information providing unit 390 provides the calculated actual image-capturing angle (a, b, c) and the image-capturing position (X, Y, Z) of the image A to the image A as position information for correction.

The position information providing unit 390 stores the data on the image A provided with the position information for correction in the position-corrected image group holding unit 3103.

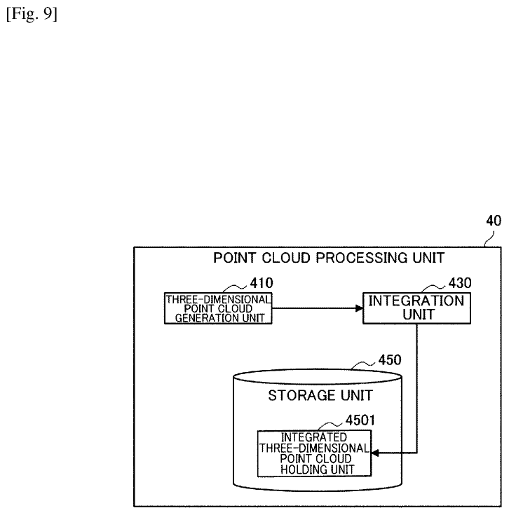

The exemplary functional configuration of the position correction unit 30 has been described with reference to FIGS. 4 to 8. Now, an exemplary functional configuration of the point cloud processing unit 40 will be described with reference to FIGS. 9 to 11.

FIG. 9 is a diagram for illustrating the exemplary functional configuration of the point cloud processing unit 40 according to the embodiment. As shown in FIG. 9, the point cloud processing unit 40 has a three-dimensional point cloud generation unit 410, an integration unit 430, and a storage unit 450.

The three-dimensional point cloud generation unit 410 has the function of generating new three-dimensional point cloud data (new point cloud data) that represents a prescribed space as a point cloud on the basis of the group of images A after the position correction held in the post-position-corrected image group holding unit 3103 of the position correction unit 30 and the corrected position information provided to each image A in the group of images A.

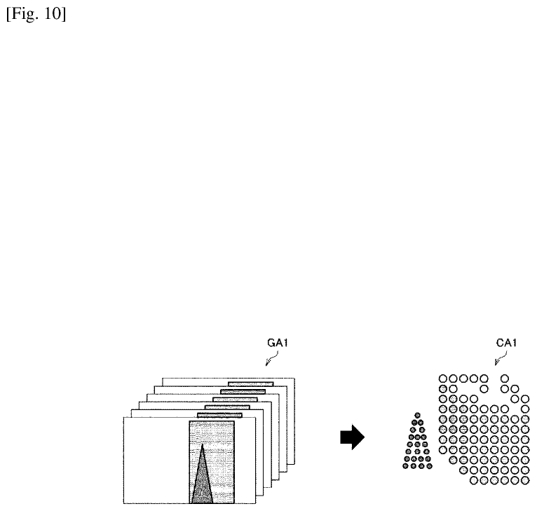

FIG. 10 is a diagram for illustrating generation of new point cloud data by the three-dimensional point cloud generation unit 410. An image group GA1 shown in FIG. 10 corresponds to the group of images A after position correction carried out by the position correction unit 30. As shown in FIG. 10, the three-dimensional point cloud generation unit 410 generates a new point cloud CA1 on the basis of the image group GA1.

The three-dimensional point cloud generation unit 410 may generate a new point cloud CA1 from the image group GA1 using SfM.

The integration unit 430 has the function of updating high-accuracy three-dimensional point cloud data using the new point cloud data generated by the three-dimensional point cloud generation unit 410.

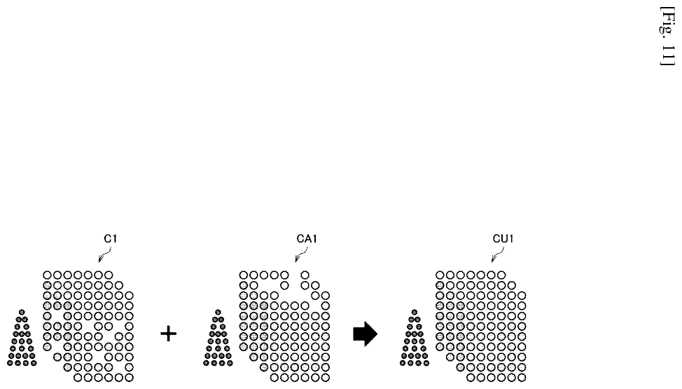

FIG. 11 illustrating updating processing for the three-dimensional point cloud data by the integration unit 430. As shown in FIG. 11, the point cloud C1 represents high-accuracy three-dimensional point cloud data held in the three-dimensional point cloud holding unit 3101. The new point cloud CA1 shows the new point cloud data generated by the three-dimensional point cloud generation unit 410. The updated point cloud CUI indicates high-accuracy three-dimensional point cloud data after the updating by the integration unit 430.

As shown in FIG. 11, the integration unit 430 may update the point cloud C1 by integrating the point cloud C1 and the new point cloud CA1.

The storage unit 450 is a device for storing various types of data. The storage unit 450 functions as an integrated three-dimensional point cloud holding unit 4501. The integrated three-dimensional point cloud holding unit 4501 holds the high-accuracy three-dimensional point cloud data after updating carried out by the integration unit 430.

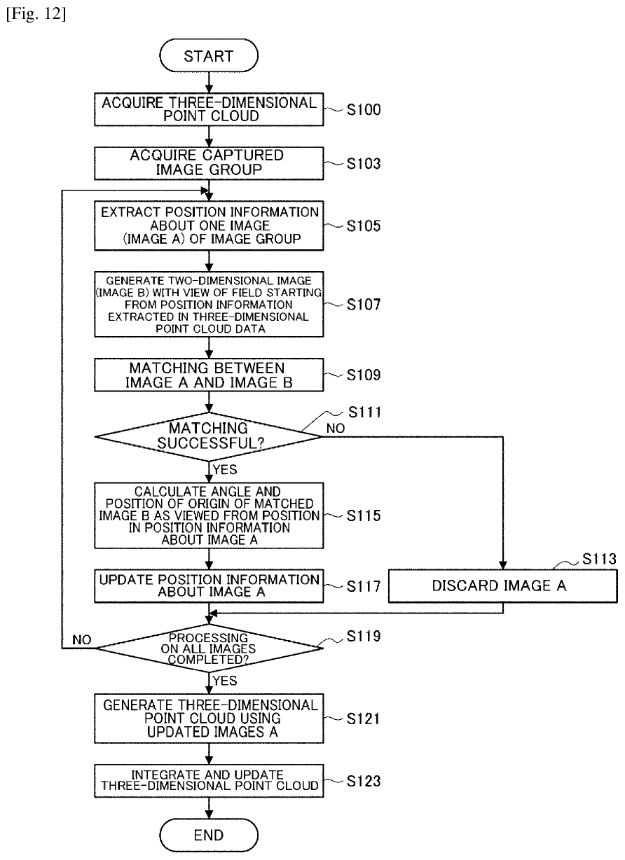

The exemplary functional configuration of the information processing apparatus 20 has been described above with reference to FIGS. 3 to 11. Next, with reference to FIG. 12, an example of the operation of the information processing system according to the embodiment will be described.

FIG. 12 is a flowchart for illustrating an example of the operation of the information processing system according to the embodiment. To start with, the image generation unit 350 acquires high-accuracy three-dimensional point cloud data held in the three-dimensional point cloud holding unit 3101 (S100).

Next, the communication unit 210 acquires, from the external device 10, a group of images of a construction site (group of images A) captured by the camera 110 and outputs the images to the position correction unit 30 and the point cloud processing unit 40 (S103).

For one image (image A) in the acquired image group, the extraction unit 330 extracts position information about the image A. The extraction unit 330 converts the extracted position information into coordinates in a three-dimensional space in the high-accuracy three-dimensional point cloud data (S105).

The image generation unit 350 generates a two-dimensional image (image B) showing the field of view starting from the position information extracted by the extraction unit 330 in the high-accuracy three-dimensional point cloud data (S107).

The matching unit 370 performs matching between the images A and B (S109). If the image A does not match the image B or the matching is not successful (No in S111), the matching unit 370 discards the image A (S113). Then, the process proceeds to S119.

If the image A matches the image B and the matching is successful (Yes in S111), the position information providing unit 390 calculates the angle and position of the origin of the matched image B as viewed from the position indicated by the position information about the image A extracted by the extraction unit 330. The position information providing unit 390 calculates position information for correction using the calculation result (S115).

The position information providing unit 390 updates the position information provided to the image A with the position information for correction. The position information providing unit 390 stores the image A with the updated position information in the position-corrected image group holding unit 3103 (S117).

The position correction unit 30 repeats the processing from S105 to S119 until the processing from S105 to S117 is completed for all the images in the group of images A acquired in S103 (No in S119).

If the processing from S105 to S117 is completed for all the images included in the acquired group of images A (Yes in S119), the three-dimensional point cloud generation unit 410 generates new point cloud data using the updated group of images A (S121).

The integration unit 430 updates the high-accuracy three-dimensional point cloud data by integrating the new point cloud data into the high-accuracy three-dimensional point cloud data held in the three-dimensional point cloud holding unit 3101. The integration unit 430 stores the updated high-accuracy three-dimensional point cloud data in the integrated three-dimensional point cloud holding unit 4501 (S123). The exemplary operation of the information processing system according to the embodiment has been described with reference to FIG. 12.

### 4. MODIFICATIONS

### <4-1. First Modification>

According to the embodiment, each of the images (images A) of the construction site acquired by the external device 10 is provided with position information acquired by the positioning unit 130. However, in the first modification, the information processing system according to the present disclosure can also be realized with a configuration in which the external device 10 does not have a positioning function using GNSS or the like.

### <4-1-1. Exemplary Functional Configuration>

In the modification, the information processing apparatus 20 and the point cloud processing unit 40 can be realized with a configuration substantially equivalent to the configuration described above with reference to FIGS. 3 and 5. In the modification, the functional configuration of an external device 11 corresponding to the external device 10 described with reference to FIG. 2 and a position correction unit 31 corresponding to the position correction unit 30 described with reference to FIG. 4 are partly different from those according to the embodiment.

### (External Device 11)

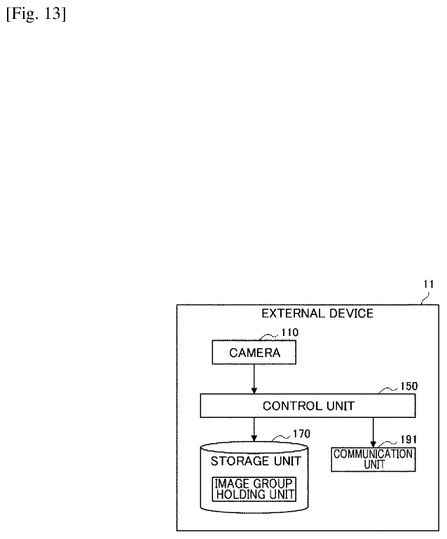

FIG. 13 is a block diagram for illustrating an exemplary functional configuration of the external device 11 according to the first modification. The external device 11 shown in FIG. 13 is different from the external device 10 described above with reference to FIG. 2 in that a positioning unit is not present. The external device 11 does not have a function to acquire position information indicating the image-capturing position of each of the images (images A) of a construction site acquired by the camera 110.

In FIG. 13, the camera 110, the control unit 150, and the storage unit 170 are the same as those described with reference to FIG. 2 and will not be described in detail here.

A communication unit 191 has the function of communicating with other devices according to the control of the control unit 150. The communication unit 191 according to the modification transmits a group of images A held in the image group holding unit of the storage unit 170 to the information processing apparatus 20 according to the control of the control unit 150. At the time, each image included in the group of images A transmitted to the information processing apparatus 20 by the communication unit 191 is not provided with position information indicating the image-capturing position.

### (Position Correction Unit 31)

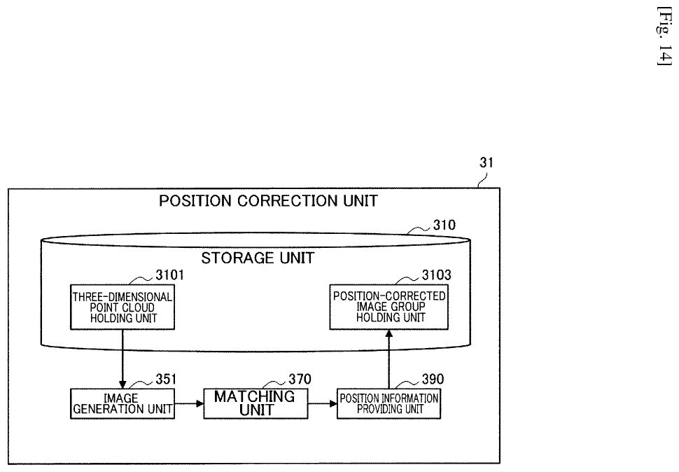

FIG. 14 is a block diagram for illustrating an exemplary functional configuration of a position correction unit 31 according to the first modification. As shown in FIG. 14, the position correction unit 31 has a storage unit 310, an image generation unit 351, a matching unit 370, and a position information providing unit 390. Since the storage unit 310, the matching unit 370, and the position information providing unit 390 have been described above with reference to FIG. 4, detailed description thereof will not be provided here.

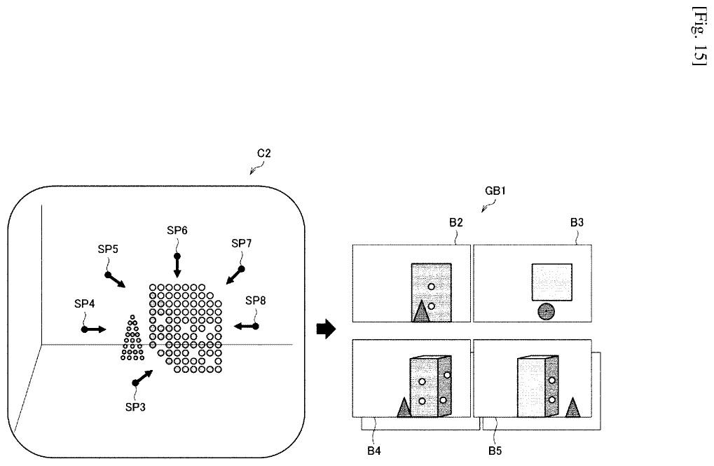

On the basis of high-accuracy three-dimensional point cloud data held in the three-dimensional point cloud holding unit 3101, the image generation unit 351 selects the origins of multiple fields of view so that each point in the high-accuracy three-dimensional point cloud data is included in at least one of the fields of view. The image generation unit 351 generates a plurality of two-dimensional images (images B) showing the fields of view from the selected plurality of origins in the above high-accuracy three-dimensional point cloud data. Now, the image generation processing by the image generation unit 351 will be described in more detail with reference to FIG. 15.

FIG. 15 is a diagram for illustrating the image generation processing by the image generation unit 351. The point cloud C2 shown in FIG. 15 represents high-accuracy three-dimensional point cloud data held in the three-dimensional point cloud holding unit 3101.

In the modification, each image in the group of images A acquired by the information processing apparatus 20 from the external device 10 is not provided with position information indicating the image-capturing position in advance. Therefore, the image generation unit 351 according to the modification selects a plurality of positions in the three-dimensional space of the high-accuracy three-dimensional point cloud data and generates images showing a plurality of fields of view starting from the selected positions as the origins.

For example, the image generation unit 351 may select the origins of the plurality of fields of view so that each point in the high-accuracy three-dimensional point cloud data is included in at least one of the fields of view.

In the example shown in FIG. 15, the image generation unit 351 selects positions SP3 to SP8 as the origins of the fields of view such that each point included in the point cloud C2 is included in at least one of the fields of view. The image generation unit 351 generates a plurality of two-dimensional images (images B) showing the fields of view starting from positions SP3 to SP8.

An image group GB1 shown in FIG. 15 is an example of the group of images B generated by the image generation unit 351. The images B2 to B5 are examples of a plurality of images B generated as images showing the fields of view from the plurality of origins selected by the image generation unit 351.

The image generation unit 351 may generate a plurality of two-dimensional images showing fields of view in multiple directions for each one of the selected plurality of origins. In the example shown in FIG. 15, using the position SP3 as the origin, a plurality of images B showing the fields of view in different directions may be generated.

The image generation unit 351 may also narrow down the range in which images indicating the field of view in the high-accuracy three-dimensional point cloud data are generated, if the range in which the camera 110 of the external device 10 included in the information processing system can take images at the construction site can be known in advance.

For example, if the external device 10 is a surveillance camera installed at the construction site, information such as the installation position, height, or angle of view of the surveillance camera may be acquired. Using the information, the image generation unit 351 may narrow down the range for generating an images showing fields of view on the basis of the high-accuracy three-dimensional point cloud data.

When the external device 10 is a moving object such as construction equipment or a drone, information on the camera 110 such as the mounting position and angle of view of the camera 110 mounted on the housing of the construction equipment or the drone may be obtained. The image generation unit 351 may narrow down the image generation range using the information about the camera 110 and the information about the expected path of movement of the construction equipment or the drone.

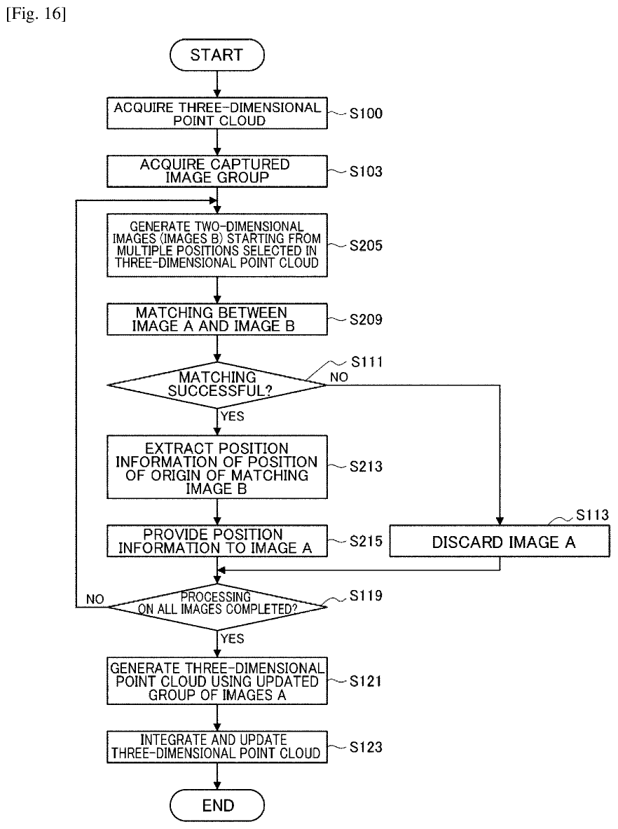

Referring to FIGS. 14 and 15, an exemplary functional configuration of the position correction unit 31 according to the first modification has been described. Now, with reference to FIG. 16, an example of the operation of the information processing system according to the modification will be described.

FIG. 16 is a flowchart for illustrating an example of the operation of the information processing system according to the first modification. In the flowchart in FIG. 16, steps S100 to S103, S111, S113, and S119 to S123 are the same as those described above with reference to FIG. 12, and detailed description thereof will not be provided here.

First, the processing from S100 to S103 are carried out. Then, the image generation unit 351 generates two-dimensional images (images B) starting from the selected multiple positions as the origins in the high-accuracy three-dimensional point cloud data (S205).

The matching unit 370 matches the image A acquired in S103 with the generated images B (S209).

The image A is matched with one of the images B, and if the matching is successful (Yes in S111), the position information providing unit 390 extracts position information about the origin of the matched image B from the high-accuracy three-dimensional point cloud data (S213). According to the modification, the position information about the origin of the matched image B is another example of second position information.

The position information providing unit 390 provides the image A with the position information about the origin of the extracted image B. The position information providing unit 390 stores the image A provided with the position information in the position-corrected image group holding unit 3103 (S215). Then, steps S119 to S123 are performed.

The example of the operation of the information processing system according to the first modification has been described with reference to FIG. 16. As described above, the image generation unit 351 according to the modification selects a plurality of position as origins in the high-accuracy three-dimensional point cloud data such that each point is included in at least one of the fields of view and generates a plurality of two-dimensional images (images B) starting from the positions. Furthermore, the position information providing unit 390 according to the modification provides the image A with the position information about the origin of the image B matched with the image A as the image-capturing position of the image A. This allows the image-capturing position of the image A to be estimated on the basis of the high-accuracy three-dimensional point cloud data even when for example the external device 10 does not have a positioning function using GNSS and the image-capturing position of the image A is unknown.

The three-dimensional point cloud generation unit 410 according to the modification generates new point cloud data on the basis of the group of images A provided with position information by the position information providing unit 390. The integration unit 430 updates the high-accuracy three-dimensional point cloud data by integrating the high-accuracy three-dimensional point cloud data and the new point cloud data. As a result, even if the external device 10 does not have a positioning function, the three-dimensional point cloud data representing the construction site can be generated and updated on the basis of the image group acquired by the external device 10.

### <4-2. Second Modification>

As a second modification of the embodiment, the external device 10 described above with reference to FIG. 2 may further include an IMU that is capable of acquiring the acceleration and angular velocity of the external device 10.

### <4-2-1. Exemplary Functional Configuration>

### (External Device 12)

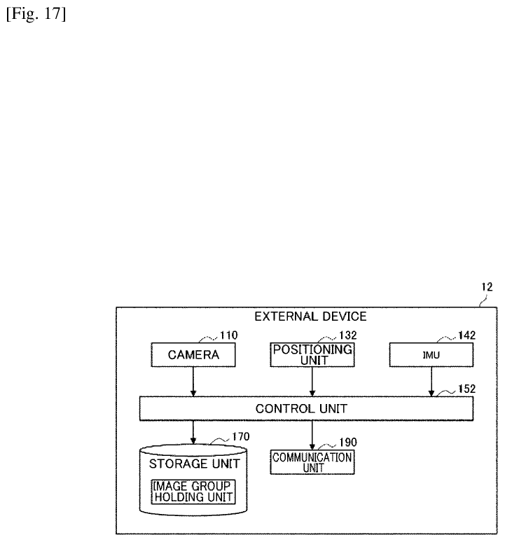

FIG. 17 is a block diagram for illustrating an exemplary functional configuration of the external device 12 according to the second modification. The external device 12 corresponds to the external device 10 described with reference to FIG. 2. As shown in FIG. 17, the external device 12 has a camera 110, a positioning unit 132, an IMU 142, a control unit 152, a storage unit 170, and a communication unit 190.

Note that the camera 110, the storage unit 170, and the communication unit 190 are described in detail with reference to FIG. 2, and detailed description thereof will not be provided.

The positioning unit 132 has substantially the same function as the positioning unit 130 described with reference to FIG. 2. Furthermore, the positioning unit 132 according to the modification has the function of determining the position of the external device 12 by combining the positioning results using GNSS with the acceleration and angular velocity information about the external device 12 obtained by the IMU 142, which will be described.

More specifically, the positioning unit 132 may perform positioning by calculating the relative position change of the external device 12 using the acceleration and the angular velocity of the external device 12 that are acquired by the IMU 142.

In this way, the accuracy of the position information provided to the images of the construction site by the positioning unit 132 is improved over the accuracy of the position information obtained by positioning using GNSS alone.

The IMU 142 is an IMU (Inertial Measurement Unit) having the function of acquiring the acceleration and angular velocity of the external device 12.

The control unit 152 has substantially the same function as the control unit 150 described with reference to FIG. 2. Furthermore, the control unit 152 according to the modification may calculate the image-capturing direction of the camera 110 on the basis of the acceleration and the angular velocity of the external device 12 acquired by the IMU 142. Furthermore, the control unit 152 may provide each image A with position information about the external device 12 calculated by the positioning unit 132 and the above image-capturing direction as position information about the image of the construction site (image A) acquired by the camera 110.

The information processing system according to the modification may also operate according to the same processing sequence as in the operation example described with reference to the flowchart in FIG. 12.

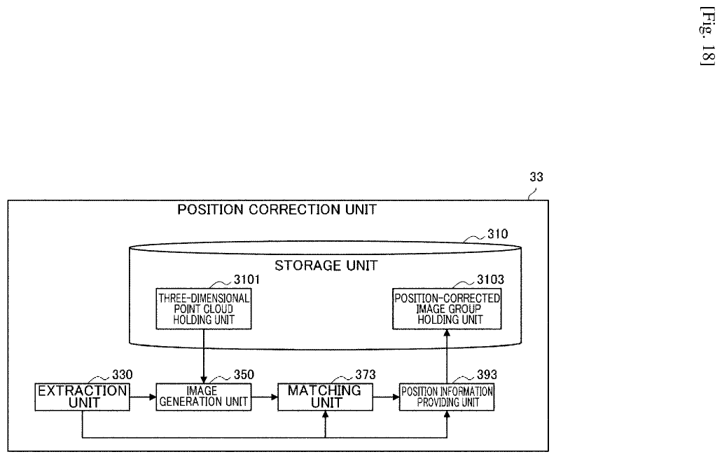

With reference to FIG. 17, the exemplary functional configuration of the external device 12 according to the second modification has been described. Now, the information processing system according to a third modification of the embodiment will be described with reference to FIGS. 18 to 20.

### <4-3. Third Modification>

According to the embodiment, the matching unit 370 of the position correction unit 30 performs matching between the image A received from the external device 10 and the image B generated by the image generation unit 350. However, the matching unit of the position correction unit 30 may perform image processing on each of the images A and B, and then perform matching on the images A and B after the image processing. For example, the matching unit of the position correction unit 30 may perform image processing to extract specific regions from the images A and B and perform matching between the images A and B after image processing.

### <4-3-1. Exemplary Functional Configuration>

### (Position Correction Unit 33)

FIG. 18 is a block diagram for illustrating an exemplary functional configuration of the position correction unit 33 according to a third modification. As shown in FIG. 18, the position correction unit 33 has a storage unit 310, an extraction unit 330, an image generation unit 350, a matching unit 373, and a position information providing unit 393. Since the storage unit 310, the extraction unit 330, and the image generation unit 350 have been described above with reference to FIG. 4, detailed description thereof will not be provided.

The matching unit 373 has a function substantially the same as that of the matching unit 370 of the position correction unit 30 described with reference to FIG. 4. Furthermore, the matching unit 373 according to the modification has the function of performing image processing to extract a region of a prescribed subject contained in each of the images A and B. The matching unit 373 also performs matching between the images A and B after the image processing.

More specifically, the matching unit 373 may select a subject whose position, shape, and direction are considered to be invariant in the prescribed space. Hereafter, a subject considered to be invariant in position, shape, and direction in a prescribed space will be referred to as invariant subject for the sake of description.

For example, specific examples of an invariant subject at a construction site may include a building and a tree which are irrelevant to construction or demolition work and expected to remain unchanged in position and shape during the construction period. It is expected that the buildings or trees will not change significantly in appearance in the images (images A) taken by the external device 10 during the construction period when taken from the same image-shooting position and direction, except when there are extraneous effects such as sunlight conditions.

The matching unit 373 selects a subject to be regarded as invariant from each of the image A received from the external device 10 and the image B generated by the image generation unit 350. For example, the matching unit 373 may use a model that has been trained by machine learning to extract a region in each of the images A and B that is considered to be invariant.

The matching unit 373 may also perform image processing on each of the images A and B, hold only an extracted region, and delete information on regions that do not correspond to the region.

Alternatively, the matching unit 373 may perform matching to each of the images A and B by setting the region of the subject regarded as invariant as the region to be processed for matching, thereby narrowing down the range to be processed.

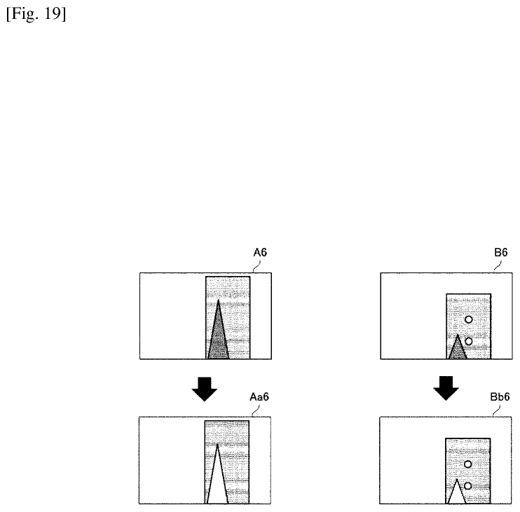

FIG. 19 is a diagram for illustrating image processing by the matching unit 373. The images A6 and B6 in the upper part of FIG. 19 represent image data before extraction of an invariant subject by the matching unit 373.

The matching unit 373 selects a subject from each of the images A6 and B6 that is considered to be invariant. In the example shown in FIG. 19, it is assumed that the hatched areas in the images A6 and B6 are extracted as areas that are regarded as invariant such as a building.

The matching unit 373 may perform image processing to each of the images A6 and B6 to hold only the extracted areas and delete information on areas that do not correspond to the areas. The images Aa6 and Bb6 in the lower part of FIG. 19 correspond to the images A6 and B6 after the image processing. Hereinafter, the images A and B after the image processing by the matching unit 373 to extract the regions of a prescribed subject will also be referred to as images Aa and Bb, respectively.

The matching unit 373 perform matching between the image A (image Aa) and the image B (image Bb) after the image processing. This may improve the accuracy of matching between the images A and B by the matching unit 373. If the accuracy of matching is improved, the accuracy of the position information for correction provided to the image A may also be improved. Therefore, the accuracy of the high-accuracy three-dimensional point cloud data after the update processing by the point cloud processing unit 40 can also be improved.

The position information providing unit 393 has substantially the same function as the position information providing unit 393 of the position correction unit 30 described with reference to FIG. 4. Furthermore, the position information providing unit 393 according to the modification calculates the angle and position of the origin of the image B corresponding to the image Bb matched with the image Aa, as viewed from the position of the position information extracted from the image A corresponding to the image Aa. The position information providing unit 393 generates position information for correction on the basis of the calculation result.

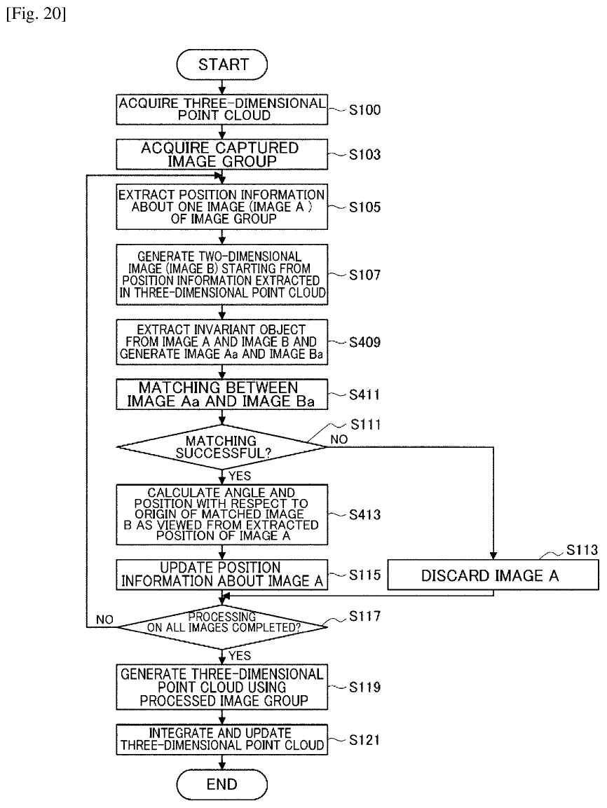

The exemplary functional configuration of the position correction unit 33 according to the third modification has been described with reference to FIGS. 18 and 19. Now, with reference to FIG. 20, an example of the operation of the information processing system according to the third modification will be described.

### <4-3-2. Operation Example>

FIG. 20 is a flowchart for illustrating an example of the operation of the information processing system according to the third modification. In the flowchart of FIG. 20, steps S100 to S107, S111, S113, and S115 to S121 are the same as those described with reference to FIG. 12, and therefore detailed description thereof will not be provided.

First, steps S100 to S107 are carried out. Then, the matching unit 373 performs image processing to extract, from each of the images A and B, the region of a subject that is regarded as invariant and generates images Aa and Bb (S409).

The matching unit 373 matches the generated images Aa and Bb (S411). Then, step S111 is performed.

When the images Aa and Bb are matched and the matching is successful (Yes in S111), the position information providing unit 393 calculates the angle and position with respect to the origin of the image B corresponding to the matched image Bb, as viewed from the position in the position information position extracted from the image A corresponding to the image Aa. The position information providing unit 393 generates position information for correction on the basis of the calculation result (S413). Then, steps S117 to S121 are performed.

### <4-4. System Configuration According to Modification>

The example of the operation of the information processing system according to the third modification has been described with reference to FIG. 20. The information processing system according to the embodiment with reference to FIG. 1 and the information processing system according to the first to third modifications of the embodiment described above can also be implemented by the following system configuration.

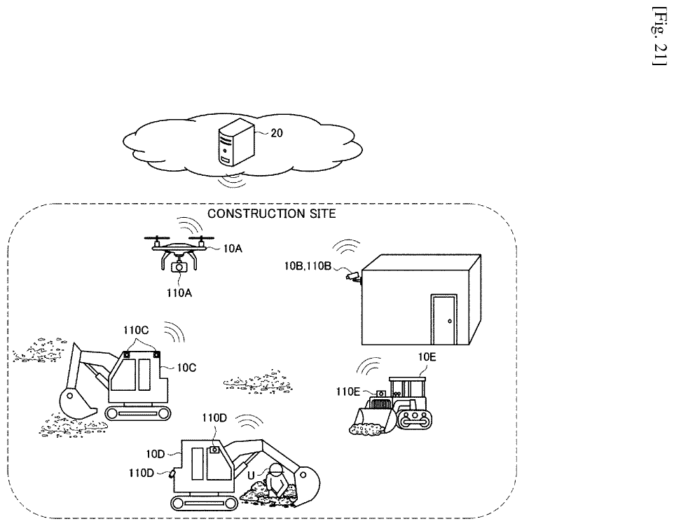

FIG. 21 is a diagram for illustrating a system configuration of the information processing system according to a modification of the embodiment. As shown in FIG. 21, the information processing apparatus 20 may be realized by a cloud server. In this case, each of the external devices 10 and the information processing apparatus 20 may communicate with each other by wireless communication.

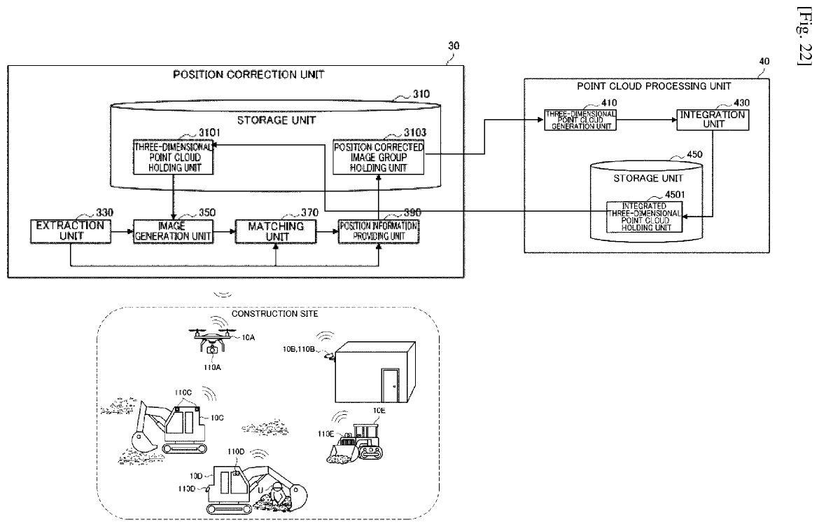

FIG. 22 is a diagram for illustrating a system configuration of the information processing system according to another modification of the embodiment. As shown in FIG. 22, the function of the information processing apparatus 20 as the position correction unit 30 and the point cloud processing unit 40 may be realized on separate devices. For example, the position correction unit 30 and the point cloud processing unit 40 may be realized on two different servers that are configured to communicate with each other. The position correction unit 30 and the point cloud processing unit 40 may be realized as cloud servers. As may be seen therein, the position correction unit 30 receives the data from a camera(s) (with or without the GNSS data) from the construction site and the three-dimensional point cloud data from the point cloud processing unit 40 and provides the second position information to the point cloud processing unit 40 to update the three-dimensional point cloud data.

### <5. Hardware Configuration>

The embodiments of the present disclosure have been described. The above described information processing apparatus 20 generates three-dimensional point cloud data from a group of images taken of a construction site, generates an image showing one field of view on the basis of the three-dimensional point cloud data, calculates position information for correction on the basis of the position of the origin of the image, provides position information to the images of the construction site, and generates and updates the three-dimensional point cloud data on the basis of the image group after the position correction, and the information processing is realized by the cooperation of software and hardware. An exemplary hardware functional configuration that can be applied to the information processing apparatus 20 will be described.

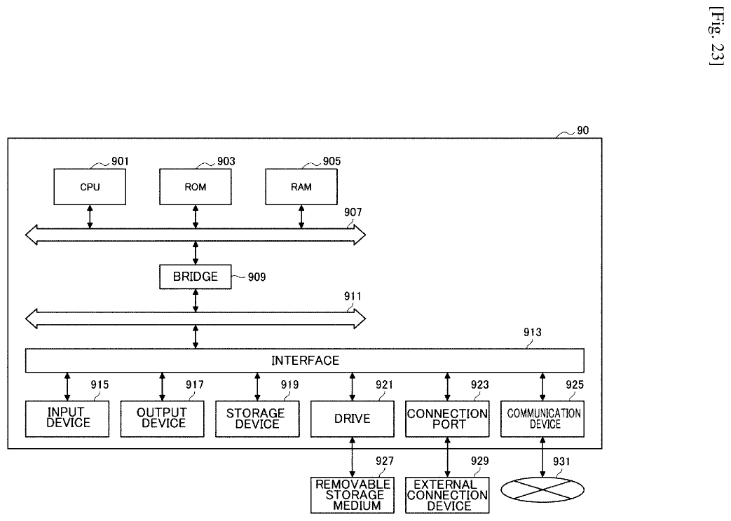

FIG. 23 is a block diagram for illustrating an exemplary hardware configuration 90. The exemplary hardware configuration 90 that will be described is only one example of the hardware configuration of the information processing apparatus 20. Therefore, the information processing apparatus 20 does not have to have all elements of the hardware configuration shown in FIG. 23. Part of the hardware configuration shown in FIG. 23 do not need to be present in the information processing apparatus 20. Furthermore, the hardware configuration 90 that will be described can be applied to the external device 10, the external device 11, and the external device 12. If the position correction unit 30 and the point cloud processing unit 40 are realized on separate devices, the hardware configuration 90 can also be applied to each of the position correction unit 30, the point cloud processing unit 40, the position correction unit 31, and the position correction unit 33.

As shown in FIG. 23, the hardware configuration 90 includes a CPU 901, a ROM 903, and a RAM 905. The hardware configuration 90 may also include a host bus 907, a bridge 909, an external bus 911, an interface 913, an input device 915, an output device 917, a storage device 919, a drive 921, a connection port 923, and a communication device 925. The hardware configuration 90 may include, instead of or together with the CPU 901, a GPU (Graphics Processing Unit), a DSP (Digital Signal Processor), and a processing circuit referred to as an ASIC (Application Specific Integrated Circuit).

The CPU 901 functions as an arithmetic processing unit and a control device and controls the operation in general or part of hardware configuration 90 according to various programs recorded in a ROM 903, the RAM 905, a storage device 919, or a removable recording medium 927. The ROM 903 stores programs and operation parameters to be used by the CPU 901. The RAM 905 temporarily stores programs to be used in the execution of the CPU 901 or parameters that change as appropriate in the execution. The CPU 901, the ROM 903, and the RAM 905 are interconnected by a host bus 907, which includes an internal bus such as a CPU bus. Furthermore, the host bus 907 is connected to an external bus 911 such as a PCI (Peripheral Component Interconnect/Interface) bus via a bridge 909.

The CPU 901 cooperates with the ROM 903, the RAM 905, and the software, so that for example the functions of the extraction unit 330, the image generation unit 350, the matching unit 370, and the position information providing unit 390 can be realized.

The input device 915 is a device such as a button operated by the user. The input device 915 may include a mouse, a keyboard, a touch panel, a switch, and a lever. The input device 915 may also include a microphone that detects the user's voice. The input device 915 may be a remote control device using infrared or other radio waves, or an external connection device 929 such as a cell phone that is compatible with the operation of the hardware configuration 90. The input device 915 includes an input control circuit that generates input signals on the basis of information input by the user and outputs the signals to the CPU 901. By operating the input device 915, the user inputs various kids of data and instructs operation of processing to the hardware configuration 90.

The input device 915 may also include an imaging device and a sensor. Using various members such as an imaging element, a CCD (Charge Coupled Device) or a CMOS (Complementary Metal Oxide Semiconductor), and a lens for controlling the formation of an object image on the imaging element, the imaging device captures an image of a real space and generates a captured image. The imaging device may be used to capture still images or moving images.

Examples of sensors include various sensors such as a distance measuring sensor, an acceleration sensor, a gyro sensor, a geomagnetic sensor, a vibration sensor, a light sensors, and a sound sensor. The sensors acquire information about the state of the hardware configuration 90 itself such as the position of the housing of the hardware configuration 90 or information about the environment surrounding the hardware configuration 90 such as the brightness or noise around the hardware configuration 90. The sensor may also include a GPS sensor that receives GPS signals to measure the latitude, longitude, and altitude of the device.

The output device 917 includes a device capable of visually or audibly notifying the user of acquired information. The output device 917 may be a display device such as an LCD (Liquid Crystal Display) or organic EL (Electro-Luminescence) display or a sound output device such as a speaker and headphones. The output device 917 may also include a PDP (Plasma Display Panel), a projector, a hologram and a printer device. The output device 917 outputs the result obtained from the processing of the hardware configuration 90 as video such as text or images or as sound such as voice or acoustics. The output device 917 may also include a lighting device to brighten the surroundings.

The storage device 919 is a device for storing data configured as an example of the storage unit of the hardware configuration 90. The storage device 919 includes a magnetic storage device such as an HDD (Hard Disk Drive), a semiconductor storage device, an optical storage device or a magneto-optical storage device. The storage device 919 stores programs or various kinds of data executed by the CPU 901 and various kinds of data acquired from external sources.

The drive 921 is a reader/writer for the removable recording medium 927 such as a magnetic disk, an optical disk, a magneto-optical disk and a semiconductor memory and is built in or provided externally to the hardware configuration 90. The drive 921 reads information recorded in the attached removable recording medium 927 and outputs the information to the RAM 905. The drive 921 also writes records in the attached removable recording medium 927.

The connection port 923 is a port for connecting a device directly to the hardware configuration 90. The connection port 923 may be a USB (Universal Serial Bus) port, an IEEE 1394 port, and an SCSI (Small Computer System Interface) port. The connection port 923 can also be an RS-232C port, an optical audio terminal or an HDMI (Registered trademark) (High-Definition Multimedia Interface) port. By connecting an external connection device 929 to the connection port 923, various kinds of data can be exchanged between the hardware configuration 90 and the external connection device 929.

The communication device 925 is a communication interface including a communication device for connecting to a local network or a communication network with a base station for wireless communication. The communication device 925 may be a communication card for wired or wireless LAN (Local Area Network), Bluetooth (Registered trademark), Wi-Fi or WUSB (Wireless USB). The communication device 925 may also be a router for optical communication, a router for ADSL (Asymmetric Digital Subscriber Line) or a modem for various types of communication. The communication device 925, for example, transmits and receives signals and other data through the Internet or to and from other communication devices using a prescribed protocol such as TCP/IP. The communication network with the local network or base station connected to the communication device 925 is a network connected by wired or wireless means such as the Internet, home LAN, infrared communication, radio wave communication or satellite communication.

### 6. CONCLUSION

The preferred embodiments of the disclosure have been described in detail with reference to the accompanying drawings, but the technical scope of the present disclosure is not limited by these examples. It is clearly understood that a person having skilled in the art in the field of the present disclosure could conceive of various modifications or corrections within the scope of the technical ideas recited in the claims, and that the modifications and corrections also naturally fall within the technical scope of the present disclosure.

For example, the steps in the processing of the operation of the external device 10 and the information processing apparatus 20 according to the embodiments do not have to be carried out in chronological order according to the sequence described in the drawings. For example, the steps in the processing of the operation of the external device 10 and the information processing apparatus 20 may be carried out in an order different from the order described in the drawings or may be carried out in parallel.

At least one computer program can also be created to cause the hardware such as the CPU, the ROM, and the RAM built in the external device 10 and the information processing apparatus 20 described above to perform the function of the information processing system according to the embodiments. A computer-readable storage medium having the at least one computer program stored therein is provided.

In addition, the effects described herein are only explanatory or exemplary and not limiting. In other words, the features of the present disclosure may produce other effects that are obvious to those skilled in the art from the description herein, either in addition to or in place of the above effects.

The following configurations are also encompassed by the technical scope of the present disclosure.

(1)

An information processing apparatus comprising
an image generation unit that generates a first image indicating a field of view in a prescribed space on the basis of three-dimensional point cloud data that represents the prescribed space by a point cloud,
a matching unit that matches a second image captured in the prescribed space and the first image, and
a position information providing unit that generates second position information on the basis of first position information about an origin of the field of view indicated by the first image matched with the second image and provides the second position information to the second image.
   (2)

The information processing apparatus according to (1) further comprising an integration unit that updates the three-dimensional point cloud data by using a plurality of the second images and new point cloud data about the prescribed space generated on the basis of the second position information provided to each of the second images.

(3)

The information processing apparatus according to (1) or (2), wherein the matching unit performs feature extraction processing for extracting a feature from each of the first image and the second image and
matches the first image and the second image by comparing the extracted features.
   (4)

The information processing apparatus according to (1) or (2), wherein the matching unit matches the first image and the first image by comparing the first image and the second image and searching for a similar region between the first image and the second image.

(5)

The image processing apparatus according to any one of (1) to (4), wherein the image generation unit generates a plurality of the first images using, as the origin, each position in a prescribed range from a position indicated in position information provided to the second image in advance as an image-capturing position of the second image.

(6)

The information processing apparatus according to any one of (1) to (5), wherein the position information providing unit generates the second position information from a position indicated by the first position information on the basis of a rotation matrix and a translation vector from the first image to the second image.

(7)

The information processing apparatus according to (5), wherein the position information provided to the second image in advance further includes information about an image-capturing direction.

(8)

The information processing apparatus according to (5), wherein the position information providing unit provides the second position information as an image-capturing position of the second image.

(9)

The information processing apparatus according to any one of (1) to (8), wherein the image generation unit selects origins for a plurality of fields of view on the basis of the three-dimensional point cloud data so that each point included in the three-dimensional point cloud data in the prescribed space is included in at least one of the fields of view, and
the image generation unit generates a plurality of the first images indicating the respective fields of view from the selected plurality of origins.
   (10)

The information processing apparatus according to (9), wherein the position information providing unit provides, to the second image, the first position information about the first image, matched with the second image from among the plurality of the first images, as the second position information.

(11)

The information processing apparatus according to any one of (1) to (10), wherein the matching unit performs image processing to extract a region of a prescribed subject included in each of the first and the second image.

(12)

The information processing apparatus according to (11), wherein the matching unit performs image processing on each of the first image and the second image to hold only the extracted region and delete information about a region which does not correspond to the region.

(13)

The image processing apparatus according to (12), wherein the matching unit matches the first and second images after the image processing.

(14)

The image processing apparatus according to any one of (11) to (13), wherein the matching unit performs processing to extract a region of the prescribed subject included in each of the first image and the second image by using a model trained by machine learning.

(15)

The information processing apparatus according to any one of (11) to (13), wherein the matching unit selects a subject regarded as invariant in position, shape, and direction in the prescribed space and sets the selected subject as the prescribed subject.

(16)

A program causing a computer to function as an information processing apparatus, the information processing apparatus including
an image generation unit that generates a first image indicating a field of view in a prescribed space on the basis of three-dimensional point cloud data that represents the prescribed space by a point cloud,
a matching unit that matches a second image captured in the prescribed space and the first image,
and a position information providing unit that generates second position information on the basis of first position information about an origin of the field of view indicated by the first image matched with the second image and provides the second position information to the second image.
   (17)

An information processing method executed by a computer, the method comprising generating a first image indicating a field of view in a prescribed space on the basis of three-dimensional point cloud data that represents the prescribed space by a point cloud,
matching a second image captured in the prescribed space and the first image; and generating second position information on the basis of first position information about an origin of the field of view indicated by the first image matched with the second image and providing the second position information to the second image.
   (18)

An information processing apparatus comprising
a matching circuit that receives a first image indicating a field of view in a prescribed space based on three-dimensional point cloud data that represents the prescribed space by a point cloud and a second image captured in the prescribed space, and matches the second image and the first image, and
a position information circuit that generates second position information based on first position information about an origin of the field of view indicated by the first image matched with the second image and provides the second position information to update the three-dimensional point cloud data.
   (19)

The information processing apparatus according (18), further comprising an integration circuit that updates the three-dimensional point cloud data by using a plurality of the second images and new point cloud data about the prescribed space generated based on of the second position information provided to each of the second images.

(20)

The information processing apparatus according to (18) or (19), wherein the matching circuit
extracts a feature from each of the first image and the second image, and matches the first image and the second image by comparing the extracted features.
   (21)

The information processing apparatus according to (20), wherein the feature is a two-dimensional feature.

(22)

The information processing apparatus according to any one of (18) to (21), wherein the matching circuit matches the first image and the second image by comparing the first image and the second image and searching for a similar region between the first image and the second image.

(23)

The image processing apparatus according to any one of (18) to (22), further comprising an image generation circuit that generates a plurality of the first images using, as the origin, each position in a prescribed range from a position indicated in position information provided to the second image in advance as an image-capturing position of the second image.

(24)

The information processing apparatus according to (23), wherein the position information providing circuit generates the second position information from a position indicated by the first position information based on a rotation matrix and a translation vector from the first image to the second image.

(25)

The information processing apparatus according to (23), wherein the position information provided to the second image in advance further includes information about an image-capturing direction.

(26)

The information processing apparatus according to (23), wherein the position information providing circuit provides the second position information as an image-capturing position of the second image.

(27)

The information processing apparatus according to any one of (18) to (26), further comprising an image generation circuit that
selects origins for a plurality of fields of view based on the three-dimensional point cloud data so that each point included in the three-dimensional point cloud data in the prescribed space is included in at least one of the fields of view, and
generates a plurality of the first images indicating the respective fields of view from the selected plurality of origins.
   (28)

The information processing apparatus according to (27), wherein the position information providing circuit provides, the first position information about the first image, matched with the second image from among the plurality of the first images, as the second position information to update the three-dimensional point cloud data.

(29)

The information processing apparatus according to any one of (18) to (28), wherein the matching circuit performs image processing to extract a region of a prescribed subject included in each of the first image and the second image.

(30)

The information processing apparatus according to (29), wherein the matching circuit performs image processing on each of the first image and the second image to hold only the extracted region and delete information about a region which does not correspond to the region.

(31)

The image processing apparatus according to (30), wherein the matching circuit matches the first image and the second image after the image processing.

(32)

The image processing apparatus according to (29), wherein the matching circuit extracts a region of the prescribed subject included in each of the first image and the second image by using a model trained by machine learning.

(33)

The information processing apparatus according to (29), wherein the matching circuit selects a subject regarded as invariant in position, shape, and direction in the prescribed space and sets the selected subject as the prescribed subject.

(34)

The information processing apparatus according to any one of (18) to (33), wherein the first image and the second image are two-dimensional images.

(35)

A non-transitory computer readable storage device having computer readable instructions that when executed by circuitry cause the circuitry to:
match a second image captured in the prescribed space and a first image indicating a field of view in a prescribed space based on three-dimensional point cloud data that represents the prescribed space by a point cloud; and
generate second position information based on first position information about an origin of the field of view indicated by the first image matched with the second image and provides the second position information to update the three-dimensional point cloud data.
   (36)

An information processing method executed by a computer, the method comprising: matching a second image captured in the prescribed space and a first image indicating a field of view in a prescribed space based on three-dimensional point cloud data that represents the prescribed space by a point cloud; and
generating second position information based on first position information about an origin of the field of view indicated by the first image matched with the second image and providing the second position information to update the three-dimensional point cloud data.

### REFERENCE SIGNS LIST

10 External device
110 Camera
130 Positioning unit
150 Control unit
170 Storage unit
190 Communication unit
20 Information processing apparatus
210 Communication unit
30 Position correction unit
310 Storage unit
3101 Three-dimensional point cloud holding unit
3103 Position-corrected image group holding unit
330 Extraction unit
350 Image generation unit
370 Matching unit
390 Position information providing unit
40 Point cloud processing unit
410 Three-dimensional point cloud generation unit
430 Integration unit
450 Storage unit
4501 Integrated three-dimensional point cloud holding unit

1. An information processing apparatus comprising:
a matching circuit that receives a first image indicating a field of view in a prescribed space based on three-dimensional point cloud data that represents the prescribed space by a point cloud and a second image captured in the prescribed space, and matches the second image and the first image; and
a position information circuit that generates second position information based on first position information about an origin of the field of view indicated by the first image matched with the second image and provides the second position information to update the three-dimensional point cloud data.

2. The information processing apparatus according to claim 1, further comprising an integration circuit that updates the three-dimensional point cloud data by using a plurality of the second images and new point cloud data about the prescribed space generated based on of the second position information provided to each of the second images.

3. The information processing apparatus according to claim 1, wherein the matching circuit
extracts a feature from each of the first image and the second image, and
matches the first image and the second image by comparing the extracted features.

4. The information processing apparatus according to claim 3, wherein the feature is a two-dimensional feature.

5. The information processing apparatus according to claim 1, wherein the matching circuit matches the first image and the second image by comparing the first image and the second image and searching for a similar region between the first image and the second image.

6. The image processing apparatus according to claim 1, further comprising an image generation circuit that generates a plurality of the first images using, as the origin, each position in a prescribed range from a position indicated in position information provided to the second image in advance as an image-capturing position of the second image.

7. The information processing apparatus according to claim 6, wherein the position information providing circuit generates the second position information from a position indicated by the first position information based on a rotation matrix and a translation vector from the first image to the second image.

8. The information processing apparatus according to claim 6, wherein the position information provided to the second image in advance further includes information about an image-capturing direction.

9. The information processing apparatus according to claim 6, wherein the position information providing circuit provides the second position information as an image-capturing position of the second image.

10. The information processing apparatus according to claim 1, further comprising an image generation circuit that
selects origins for a plurality of fields of view based on the three-dimensional point cloud data so that each point included in the three-dimensional point cloud data in the prescribed space is included in at least one of the fields of view, and
generates a plurality of the first images indicating the respective fields of view from the selected plurality of origins.

11. The information processing apparatus according to claim 10, wherein the position information providing circuit provides, the first position information about the first image, matched with the second image from among the plurality of the first images, as the second position information to update the three-dimensional point cloud data.

12. The information processing apparatus according to claim 1, wherein the matching circuit performs image processing to extract a region of a prescribed subject included in each of the first image and the second image.

13. The information processing apparatus according to claim 12, wherein the matching circuit performs image processing on each of the first image and the second image to hold only the extracted region and delete information about a region which does not correspond to the region.

14. The image processing apparatus according to claim 13, wherein the matching circuit matches the first image and the second image after the image processing.

15. The image processing apparatus according to claim 12, wherein the matching circuit extracts a region of the prescribed subject included in each of the first image and the second image by using a model trained by machine learning.

16. The information processing apparatus according to claim 12, wherein the matching circuit selects a subject regarded as invariant in position, shape, and direction in the prescribed space and sets the selected subject as the prescribed subject.

17. The information processing apparatus according to claim 1, wherein the first image and the second image are two-dimensional images.

18. A non-transitory computer readable storage device having computer readable instructions that when executed by circuitry cause the circuitry to:
match a second image captured in the prescribed space and a first image indicating a field of view in a prescribed space based on three-dimensional point cloud data that represents the prescribed space by a point cloud; and
generate second position information based on first position information about an origin of the field of view indicated by the first image matched with the second image and provides the second position information to update the three-dimensional point cloud data.

19. An information processing method executed by a computer, the method comprising:
matching a second image captured in the prescribed space and a first image indicating a field of view in a prescribed space based on three-dimensional point cloud data that represents the prescribed space by a point cloud; and
generating second position information based on first position information about an origin of the field of view indicated by the first image matched with the second image and providing the second position information to update the three-dimensional point cloud data.
